(19) United States
(12) Patent Application Publication
(10) Pub. No.: US 2007/0192152 A1
(43) Pub. Date: Aug. 16, 2007

(54) Software phase sequencer editor and method of editing

(75) Inventor: Eric A. Frank, Waukesha, WI (US)

Correspondence Address: RATNERPRESTIA, P O BOX 980, VALLEY FORGE, PA, 19482-0980, US

(73) Assignee: ITT Manufacturing Enterprises, Inc.

(21) Appl. No.: 11/352,787

(22) Filed: Feb. 13, 2006

(51) Int. Cl. G05B 19/418

(52) U.S. Cl. 705/8

(57) ABSTRACT

A phase sequence system for performing a task is disclosed. The system includes a controller operationally connected to a system and operational software for operating the system. The operational software comprises a sequence of numbers to perform the task. A phase editor is operationally connected to the controller to edit the sequence of numbers. A method of editing the system is also disclosed.

### BACKGROUND OF THE INVENTION

Computer programs are often used to automate steps in processes that are complicated or require repetition. Typically, the computer programs are long and complicated themselves, with hundreds or thousands of lines of code. The code instructs sequences of operations of different phases in a particular order to accomplish a desired task. The programs are often specifically written for the particular task at hand, making it difficult to port the program or even a portion of the program for another task.

While the particular task for which the software is written may be a relatively complex task, such a task is typically comprised of a number of well-known, less complicated, subtasks. These subtasks may include steps such as performing a single process or performing well-defined steps in the process. Addition, removal, or rearrangement of the order of subtasks for a given task may produce an entirely different task, but the change required in conventional operating software to do so may be so cumbersome that it may be more efficient to simply write a new program to perform the different task.

It would be beneficial to provide a program for performing a task that is easy to modify to adjust the performance of the task or to perform a different task. It would also be beneficial to provide a user-friendly interface to allow an operator to modify the program without necessarily knowing how the software for the program is written or having to rewrite the software.

### SUMMARY OF THE INVENTION

Briefly, the present invention provides a phase sequence system for performing a task. The system comprises a plurality of phases, wherein each phase is represented by a number. The system also comprises means for arranging at least a subset of the numbers in a sequence of phases to perform the task and means for allowing an operator to individually edit a phase in the sequence.

Further, the present invention also provides a method of editing phases in a process. The method comprises the steps of selecting a program edit routine from an operator interface; selecting a program to edit from the selected program edit routine; selecting a phase to edit from the selected program, wherein the phase is represented by a number; and editing the number.

Additionally, the present invention comprises a phase sequence system for performing a task. The system comprises a controller operationally connected to a system and operational software residing in the controller for operating the system. The operational software comprises a sequence of numbers to perform the task. A phase editor is operationally connected to the controller to edit the sequence of numbers.

Further, the present invention provides a method of programming a series of phases to perform a task comprising the steps of: a) providing a plurality of phases, wherein each phase is represented by a different number; b) determining a phase required to perform the task; c) selecting the number associated with the phase; d) inputting the number into a program; and e) repeating steps a-d as necessary to include all of the phases necessary to complete the task.

Also, the present invention provides a method of performing a task comprising the steps of: providing a system upon which the task is to be performed; operationally connecting a controller to the system, wherein the controller includes a sequence of numbers, with each number associated with a phase; and operating the controller, wherein the controller controls the operation of each phase according to the sequence of numbers.

### BRIEF DESCRIPTION OF THE DRAWINGS

The foregoing summary, as well as the following detailed description of a preferred embodiment of the invention, will be better understood when read in conjunction with the appended drawings, which are incorporated herein and constitute part of this specification. For the purposes of illustrating the invention, there are shown in the drawings an exemplary embodiment of the invention. It should be understood, however, that the invention is not limited to the precise arrangements and instrumentalities shown. In the drawings, the same reference numerals are employed for designating the same elements throughout the several figures. In the drawings:

FIG. 1 is a screen display of a representative system that employs a software phase sequencer according to an exemplary embodiment of the present invention;

FIG. 2 is a schematic drawing of a controller used to control the system of FIG. 1;

FIG. 3 is a screen display of a program setpoints edit screen used to edit setpoints for the system displayed in FIG. 1;

FIG. 4 is a screen display of a program selection edit screen used to select a program for the system displayed in FIG. 1;

FIG. 5 is a screen display of a first page of a program edit menu used to edit a program for the system displayed in FIG. 1;

FIG. 6 is a screen display of a second page of a program edit menu used to edit a program for the system displayed in FIG. 1;

FIG. 7 is a list of phase descriptions available for use on the system displayed in FIG. 1;

FIG. 8 is a table listing the order of phase descriptions to perform a predefined process on the system displayed in FIG. 1;

FIG. 9 is a Phase Sequence Chart showing phases available to perform a task and elements of the system displayed in FIG. 1 that are in use to perform each phase;

FIGS. 10A-10C are a printout of representative PLC software used to executed the sequence of phases, phase times, and outputs as described in FIG. 9;

FIG. 11 is a printout of representative PLC software used to edit the program; and

FIGS. 12A-12D are a printout of representative PLC logic for outputs.

### DETAILED DESCRIPTION OF THE INVENTION

Certain terminology is used herein for convenience only and is not to be taken as a limitation on the present invention. The terminology includes the words specifically mentioned, derivatives thereof and words of similar import. The following describes an exemplary embodiment of the invention. However, it should be understood based on this disclosure, that the invention is not limited by the disclosed embodiment of the invention.

While numbers are used to designate each phase in the inventive system and process as described herein, those skilled in the art will recognize that letters, symbols, or combinations thereof may be used. Therefore, as used herein, the term “numbers” is preferably construed to include numbers, letters, symbols, and combinations thereof.

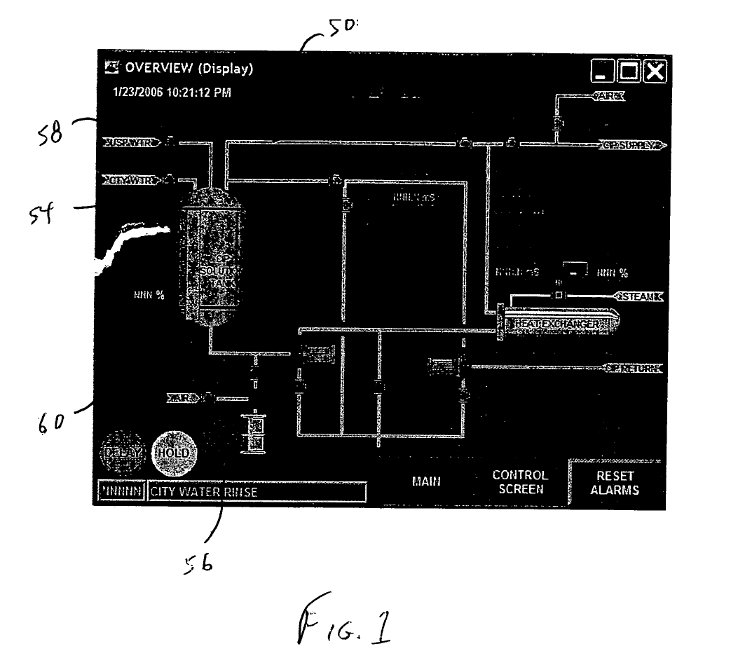

Referring generally to FIGS. 1-11, the present invention relates to a system and a method for automatically performing a task through a computer program containing a sequence of numbers, wherein each number represents a phase to be completed in sequence to accomplish the task. The present invention also provides an interface and a method to edit the sequence of numbers in order to modify the task, as well as to modify the length of time required to perform a particular phase.

FIG. 1 shows a screen display of a schematic for a representative system that utilizes the computer program and the editing interface according to the present invention. The present invention is described herein for use with a system and a method for operating the fluid system, such as a clean-in-place (CIP) system 50, although those skilled in the art will recognize that the present invention may be adapted for other systems and processes.

The exemplary portable CIP system 50 that is described herein and shown in FIG. 1 is used for cleaning a tanks and other applicable external equipment (not shown) using predefined sequences of phases. The CIP process, or “recipe”, preferably contains a sequence of phases (i.e. PRE-RINSE, WASH, USP RINSE, AIR BLOW, etc.). A Programmable Logic Controller (PLC) is operatively connected to the CIP system 50 to control operation of these phases for a set time or until a condition is met as dictated by the phase type and recipe. Once the recipe is loaded into the PLC and an operator starts the CIP process, the CIP system 50 will automatically start sequencing through the phases from start to finish.

The exemplary CIP process is as follows. A pre-rinse phase uses once-through city water 54 to flush the external equipment and remove any residual product left over from production. A wash phase uses a caustic solution 56 to dislodge product from the interior surfaces of the external equipment. City water 54 is used again to rinse the external equipment after the caustic wash. This second city water wash conserves USP water (pure or fully deionized water used for the production of injection products which meets the regulations set by the U.S. Pharmacopoeia) 58. After the second city water rinse has removed most of the caustic solution 56, a hot USP water 58 final rinse is performed. Hot USP water 58 is supplied for the final once through rinse of all internal surfaces of the external equipment. The system piping 60 is then drained for a set time. Once the system 50 is drained, an air blow is done to remove any remaining USP water 58 in the CIP piping 60. When the air blow is completed, the CIP process stops.

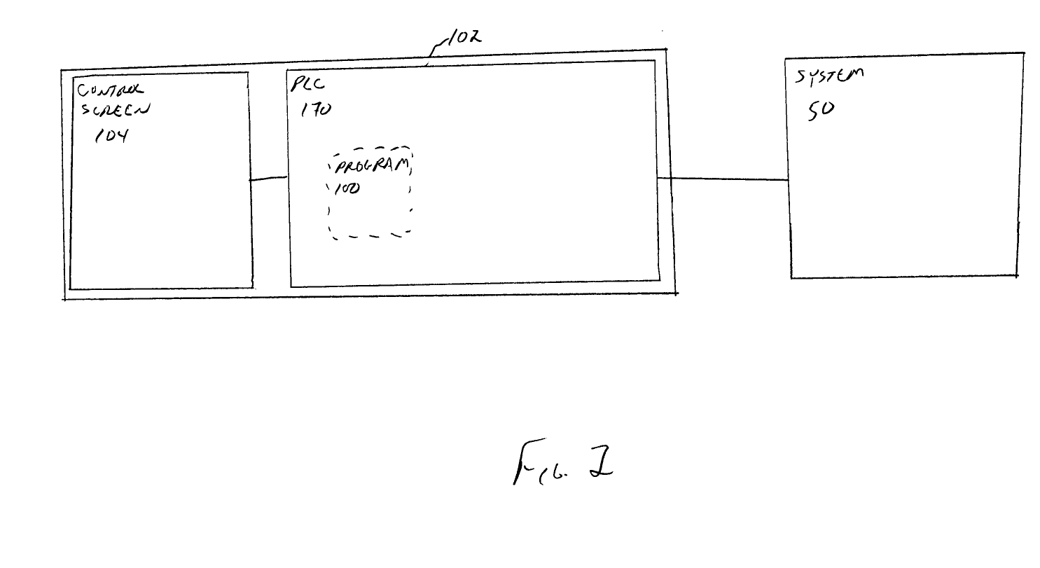

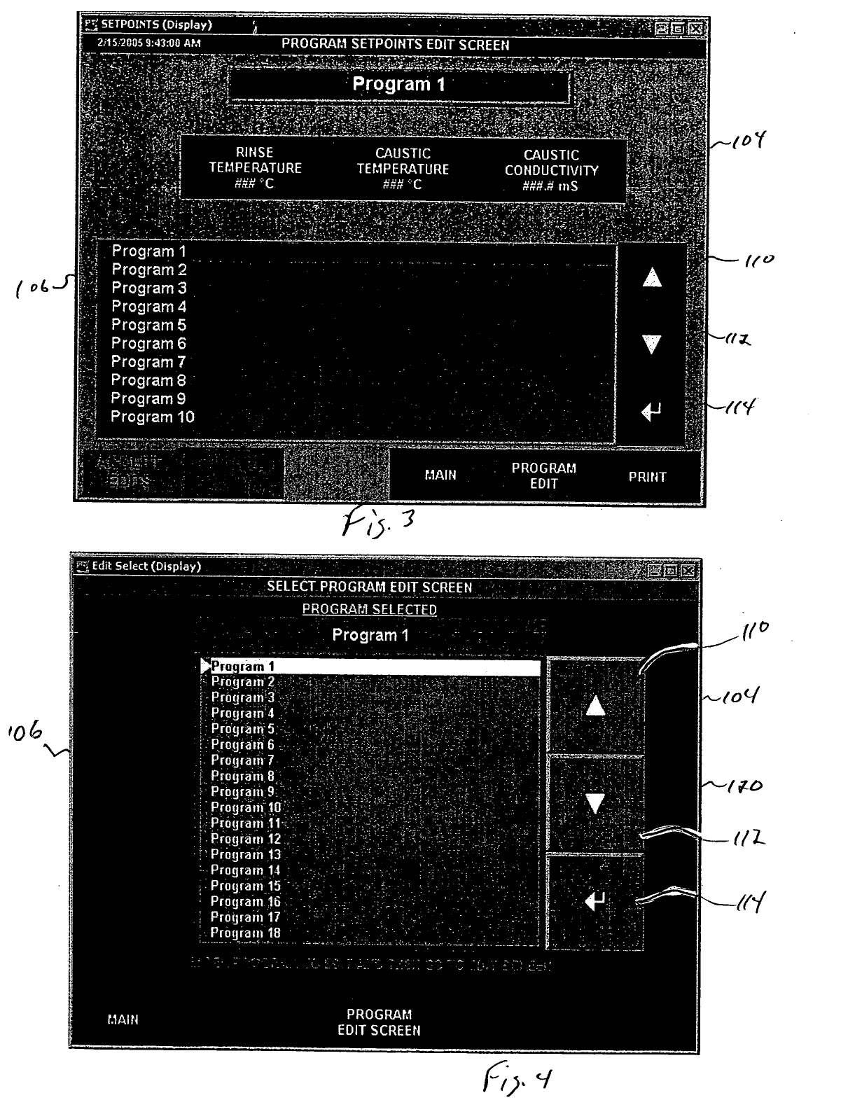

Referring to FIG. 2, a computer program 100, designed to automatically perform the CIP process as described above, is resident in a controller system 102. The controller system 102 is operatively connected to the CIP system 50 to operate all of the phases necessary to perform the CIP process described above, as well as to edit the phases, if necessary. The program 100 contains a data table of a sequence of numbers, with each number being associated with a step, or phase, in the process. The controller system 102 includes the program 100 and an operator interface, such as a control screen 104, which is shown in FIG. 3. The screen 104 is preferably a touch screen that is activated through direct touch. Alternatively, the screen 104 may be activated with a point-and-click device, such as a computer mouse, a trackball, or some other suitable device.

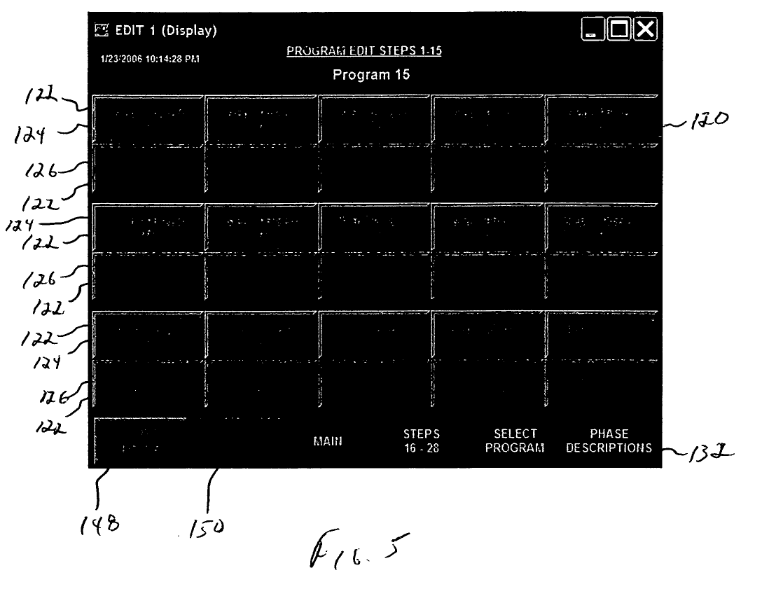

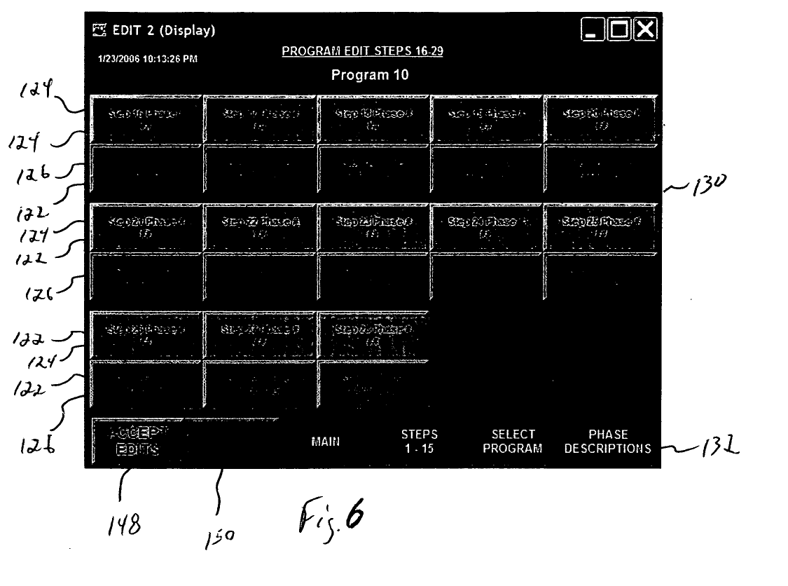

Referring to FIG. 4, the screen 104 projects a screen display 106 that lists multiple programs that are available for editing. The screen display 106 shows the programs that are available for editing, with up/down arrow buttons 110, 112 to enable a operator to scroll through the list of programs, and an “ENTER” (or “RETURN”) button 114 to select the desired program for editing. Once the selected program (for example, Program 10) is selected, the screen display 106 changes to a program edit screen 120, shown in FIG. 5.

After the program is selected, the phases required to accomplish that program are displayed in step edit boxes 122. For each step, a phase number and time are listed. The phase is the process to perform during the step, such as, for example, “USP RINSE”, “FILL TANK WITH CITY WATER”, “CAUSTIC WASH”, or other phases required to perform the programmed task. A “PHASE DESCRIPTIONS” button 124 allows an operator to view all of the phases and their corresponding phase numbers available for the program. Each step also includes an associated timer button 126 that lists the time that the phase will remain active, after preconditions, if any, are met. An example of a precondition would be waiting for temperature to reach a predetermined setpoint or waiting for the caustic level to reach a predetermined setpoint before starting the timer. Certain phases do not require a time, but rather just a precondition, such as high level in the tank during a fill tank phase.

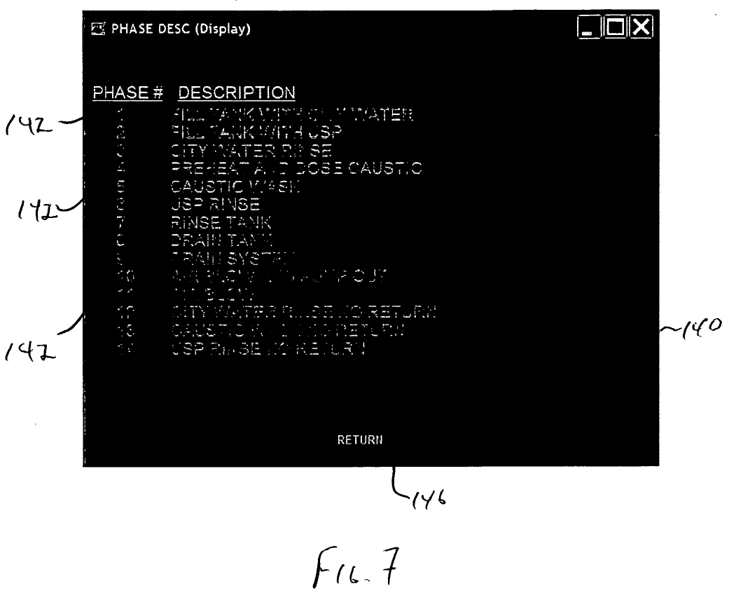

As presently configured, the maximum number of steps to perform a desired task is 28. However, those skilled in the art will recognize that the PLC code can easily be modified to handle more than 28 steps. The screen 120 displays steps 1-15 for the program selected. If the operator wishes to view and/or edit any remaining steps, a button 128 for the remaining steps (in this case, steps 16-28) is provided. Activation of the button 128 changes the screen 120 to a subsequent program edit screen 130, shown in FIG. 6, which displays steps 16-28. To edit a phase or time for any of steps 1-28, the desired screen 120, 130 is selected. To enter a new value for a particular step, the operator presses on the desired step edit box 122 and enters a new value. In the exemplary embodiment, the value is a number associated with a particular step. After the desired step edit box 122 is pressed, a numeric keypad (not shown) appears on the screen 120, 130 and allows the operator to input the desired number, and then press “ENTER” to enter the value into that particular step. To enter a new time value for a particular step, the operator presses on the desired timer button 126 and enters a time value. After the desired timer button 126 is pressed, a numeric keypad (not shown) appears on the screen 120, 130 and allows the operator to input the desired time, and then press “ENTER” to enter the time value into that particular step. The process is repeated for each successive step until all of the steps necessary to complete the task are entered. Any unused steps all have a zero value entered. For example, if only 20 steps are required to complete a task, steps 21-28 all have a zero value entered.

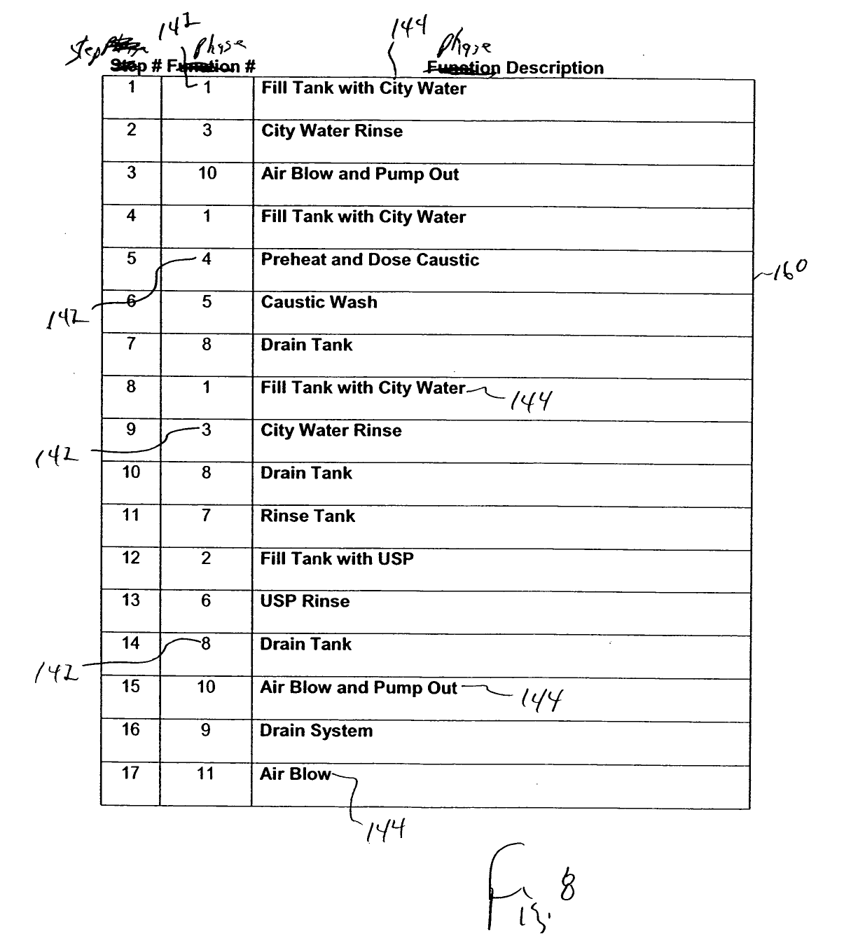

Referring to FIGS. 5 and 6, a “PHASE DESCRIPTIONS” button 132 directs the operator to a phase descriptions screen 140, shown in FIG. 7. The phase descriptions screen 140 lists descriptions of all of the available phases to perform the desired task. Each phase description is associated with a phase number 142, which is input into the phase that has been selected from the PROGRAM EDITS screen 120, 130. For this particular task of operating the portable CIP system 50, fourteen different phases are available. However, those skilled in the art will recognize that additional phases may be provided in the phase descriptions screen 140 to allow an operator a greater selection of programming options to be able to perform additional, different tasks. The phase number 142 and configured output for that particular phase are stored in a storage file in the PLC. A “RETURN” button 146 returns the operator to the previous screen 120, 130 (FIGS. 5 and 6).

On either screen 120, 130, an “ACCEPTS EDITS” button 148 allows the operator to save the changes to a “program storage” file in the PLC. If the operator wants to cancel the edits made, a “CANCEL EDITS” button 150 is provided to restore the original program. The program edit screen 120, 130 is preferably secured to restrict access.

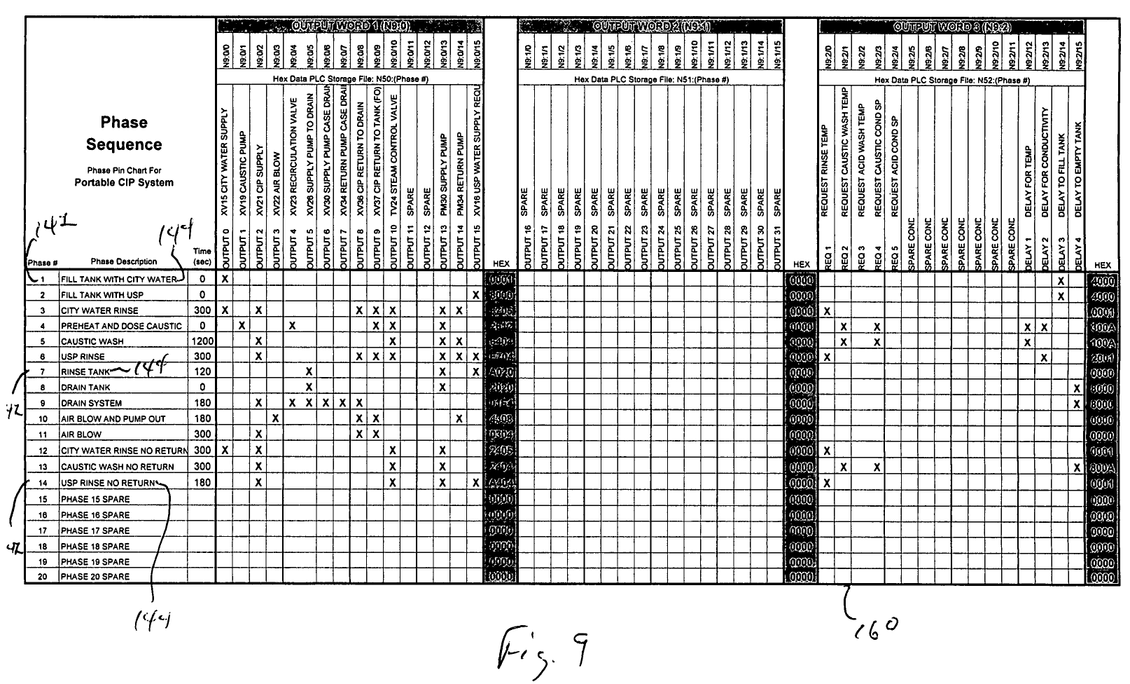

FIG. 8 is a table 160 showing 17 phases required to complete a particular task. The table 160 lists phase numbers 142 in the sequence that the phases are to be performed in order to accomplish the task. Each phase number 142 corresponds to a different phase 144. The phase numbers 142 to complete this particular task are listed in the sequence 1, 3, 10, 1, 4, 5, 8, 1, 3, 8, 7, 2, 6, 8, 10, 9, 11. It should be noted that some phases 144, such as those phases 144 associated with the phase numbers 1, 8, 10, are performed more than one time during the task, while other phases 144, such as those phases 144 associated with the phase numbers 12, 13, 14, are not required to accomplish the task and are therefore omitted from the sequence. Since only 17 phases are required to complete the task, phase buttons 18-28 associated with program edit screen 130 all contain a zero (0) value. A “0” in the sequence ends the sequence.

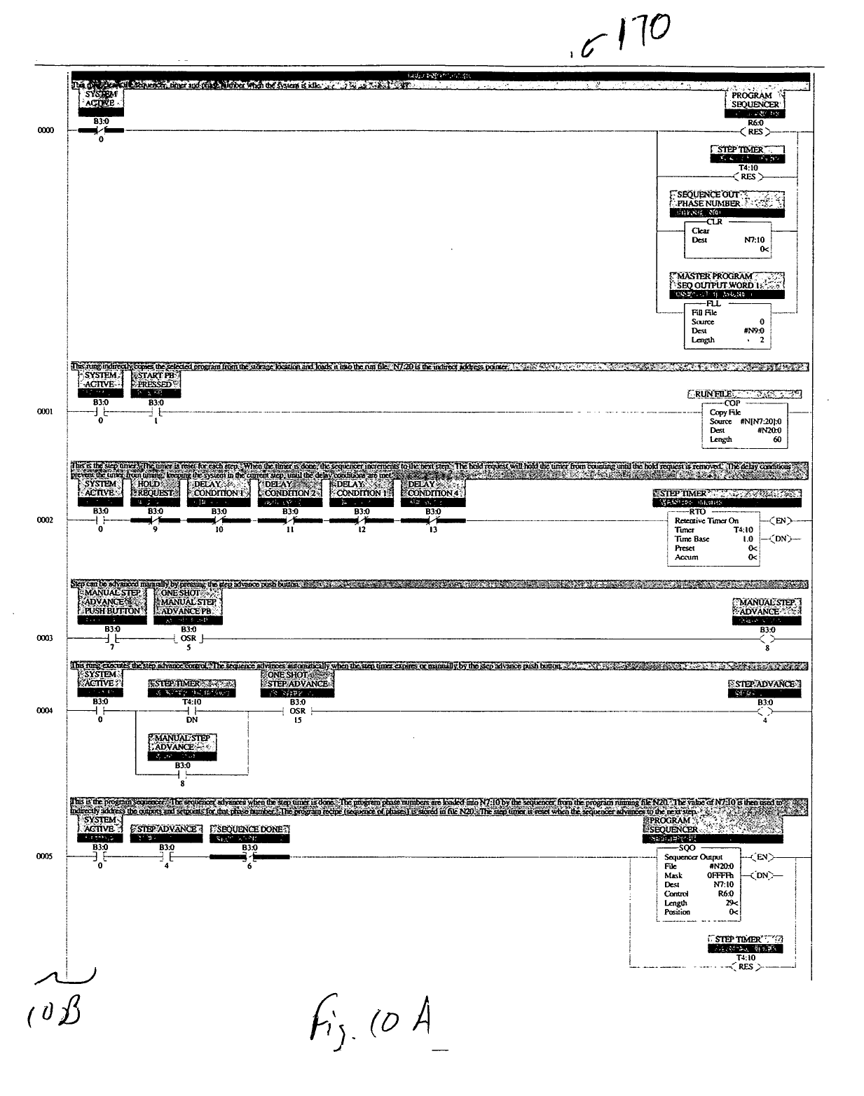

A Phase Sequence Chart 160, shown in FIG. 9, associates each of the fourteen listed phases with conditions required to accomplish each phase. The Phase Sequence Chart 160 shows which devices (outputs) will be enabled per phase and what preconditions are associated with each phase. The preconditions are listed as delay conditions. For example, for Phase 1, “FILL TANK WITH CITY WATER”, the CITY WATER SUPPLY will be enabled and a DELAY TO FILL TANK condition must be met to accomplish the phase. For Phase 3, “CITY WATER RINSE”, the CITY WATER SUPPLY, CIP SUPPLY, CIP RETURN TO DRAIN, CIP RETURN TO TANK (FO), STEAM CONTROL VALVE, SUPPLY PUMP, RETURN PUMP, and REQUEST RINSE TEMP will be enabled to accomplish the phase.

The Phase Sequence Chart 160 is a tool to generate a hex data number and to visually see the outputs for each phase. The hex data is entered manually into the PLC code. The hex data is entered once and will not need to be changed unless the operation of the phase is changed. The 14 phases shown are examples. Each task requires a specific set of phases, but the software remains the same (just different phase names and the amount of outputs may change). The phase edit boxes 122 are used to pick and choose the phases and the order of the sequence. The tasks for each phase are set in PLC code 170 based on the hex data entered.

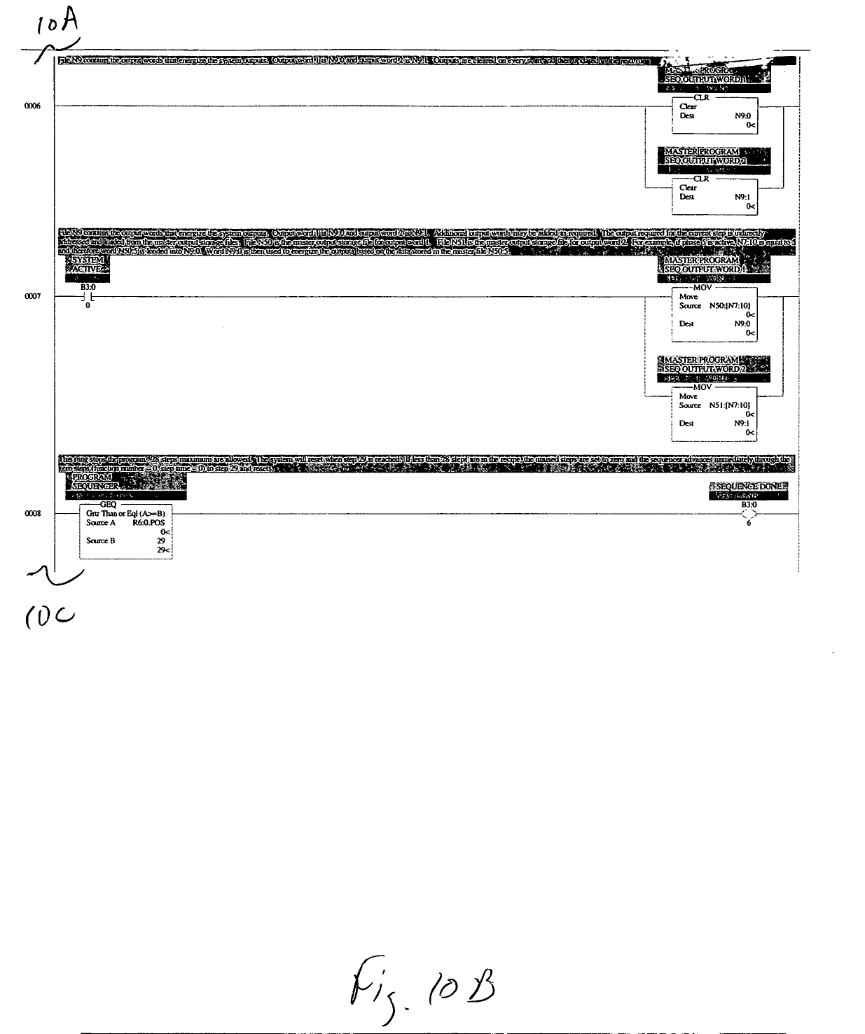

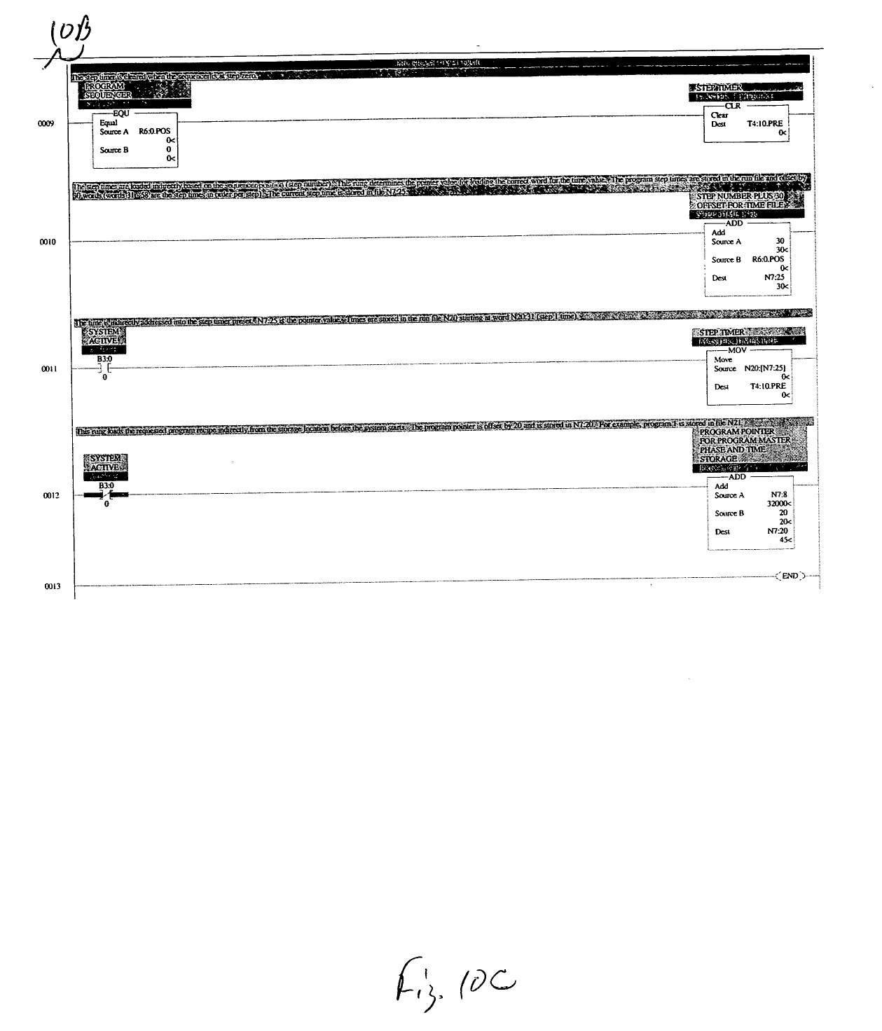

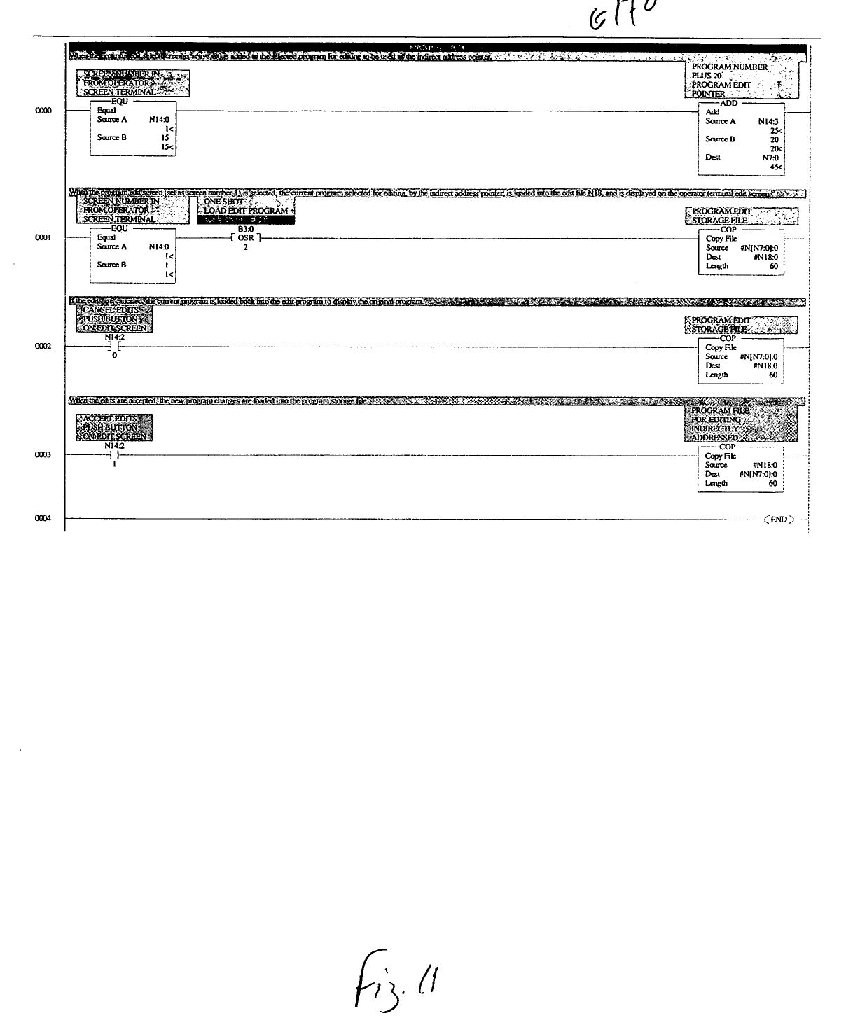

A representative printout of PLC code 170 that is used to complete a selected phase is shown in FIGS. 10A-10C. One skilled in the art of PLC programming will readily be able to review the PLC code 170 to determine its operation.

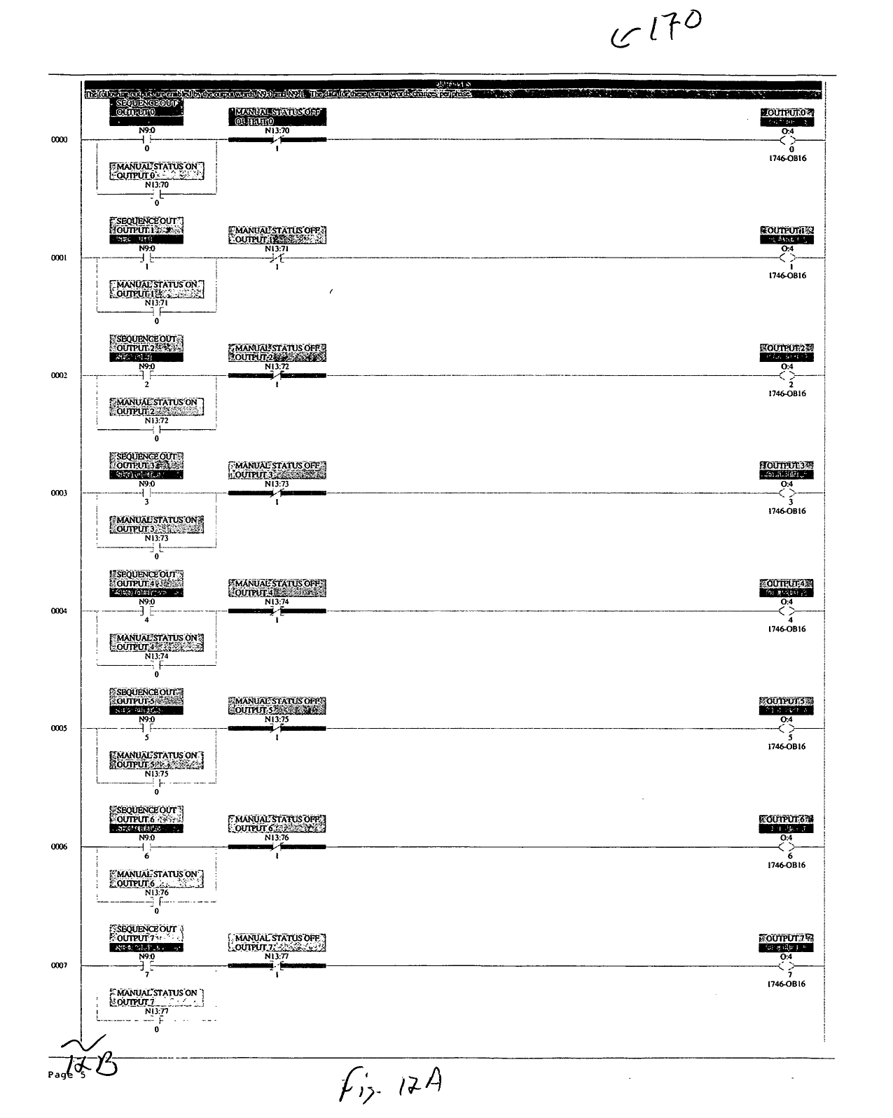

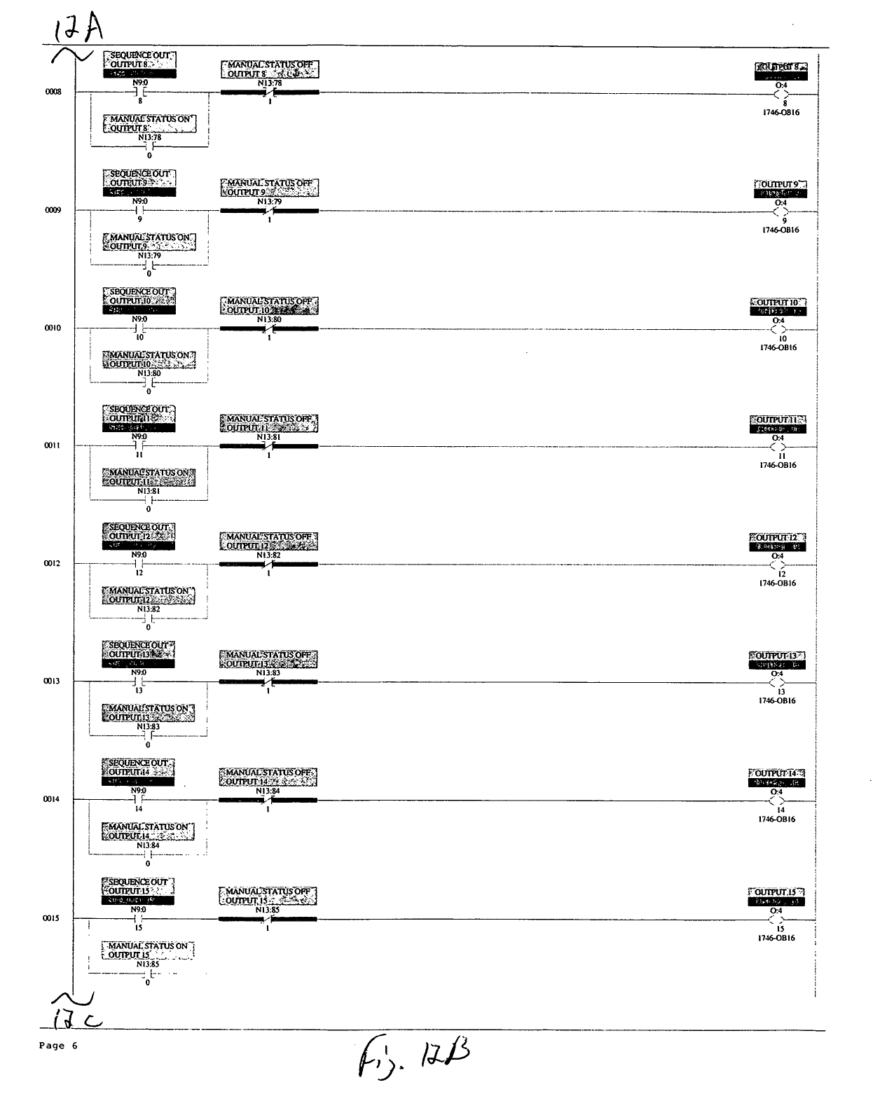

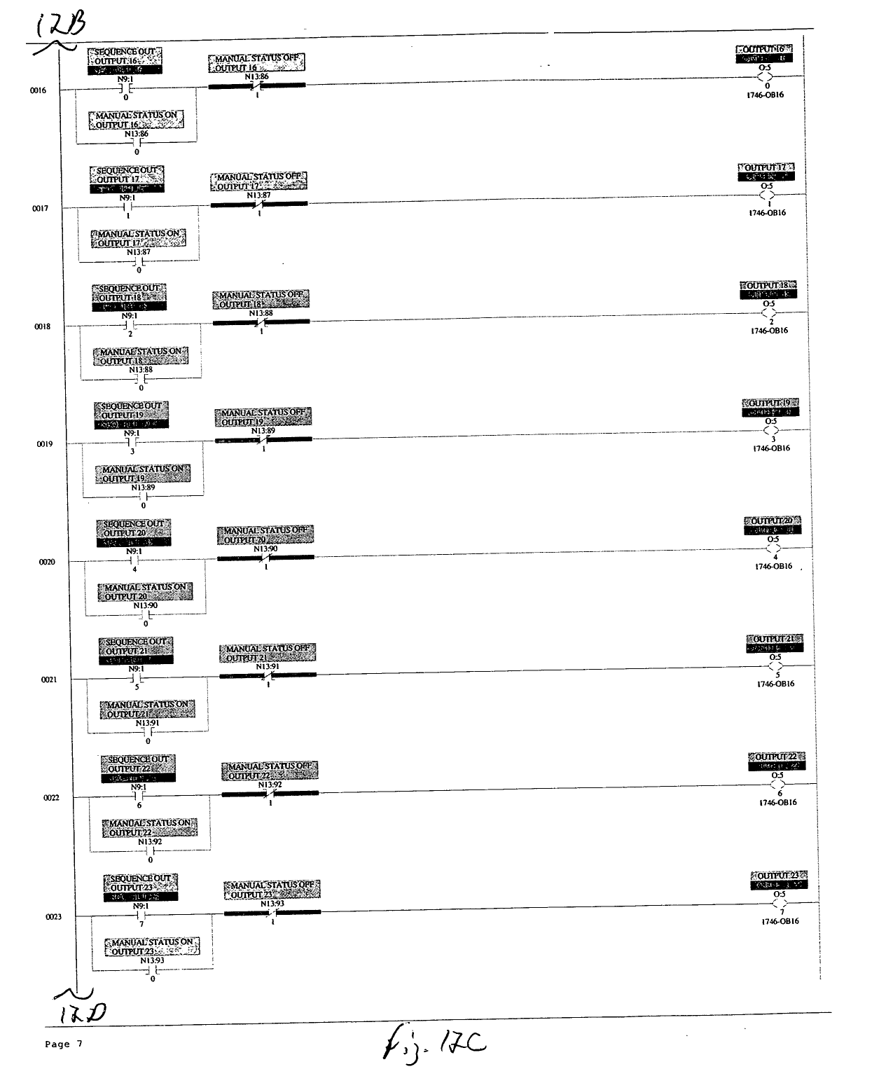

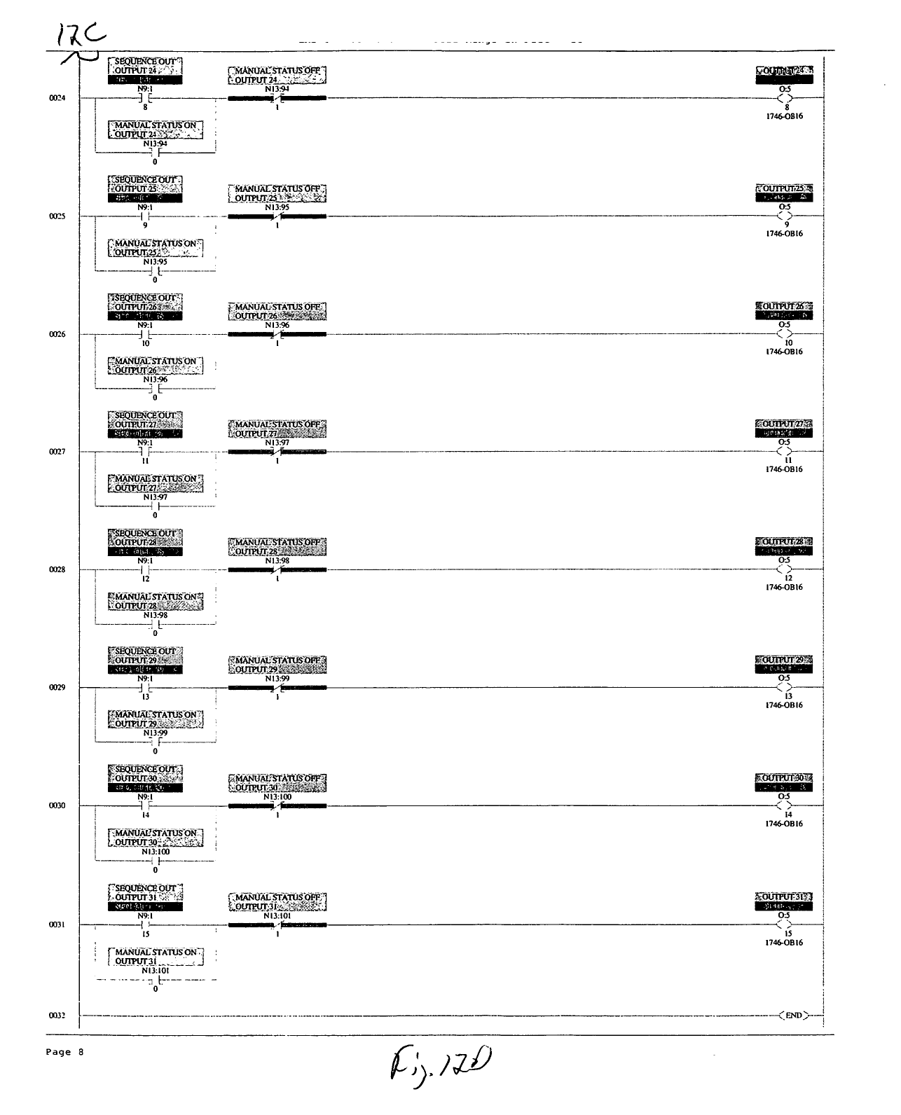

If additional phases are required in mid-task to complete the task or to modify the task to complete a different task, then the user selects the task from the Program Edit Screen 110, shown in FIG. 4. The Program Edit Screen 120, shown in FIG. 5, appears and the user edits the phase numbers and time for each step on the program edit screen 120. A representative printout of PLC code 170 that is used to perform program edits is shown in FIG. 11 and a representative printout of PLC code 170 outputs is shown in FIGS. 12A-12D.

If, for example, the original task requires the phases 4, 2, 5, 7, 1, 2, 9, and phase 3 is required to be added between steps 3 and 4, the new task will be 4, 2, 5, 3, 7, 1, 2, 9. Step 4 will be accessed and the original phase 7 will be replaced by phase 3. Next, step 5 will be accessed and the original phase 1 will be replaced by the phase 7 that was originally in the previous phase. The remaining phases 1, 2, 9 will be input into steps 6, 7, 8, respectively. After the edits are made and the user wants to save the edits, the user presses the “ACCEPT EDITS” button 148 to accept the edits.

If phases are required to be deleted from a sequence, the user selects the task from the Program Edit Screen 110, shown in FIG. 4. The Program Edit Screen 120, shown in FIG. 5, appears and the user edits the function numbers on the program edit screen 120.

If, for example, the original sequence is 4, 2, 5, 7, 1, 2, 9, and step 3 is required to be removed from the new sequence, the new sequence will be 4, 2, 7, 1, 2, 9, with the remaining phases for each step after the last step all being 0. Step 3 will be accessed and the original phase 5 will be replaced by phase 7. Next, phase 4 will be accessed and the original phase 7 will be replaced by phase 2 that was originally in the subsequent step. The remaining phase 9 will be input into step 6. The phase 9 that was originally in step 7 will be replaced with 0, indicating that the task is complete. After the edits are made and the user wants to save the edits, the user presses the “ACCEPT EDITS” button 148 to accept the edits.

If a time duration for a particular step needs to be edited, the user selects the task from the Program Edit Screen 110, shown in FIG. 4. The Program Edit Screen 120, shown in FIG. 5, appears and the user edits the value for the time or the condition on the program edit screen 120. After the edits are made and the user wants to save the edits, the user presses the “ACCEPT EDITS” button 148 to accept the edits.

The program 100 allows the user to swiftly and easily edit phases of an operation to modify the operation or to develop a new operation, without the need to start writing software from scratch.

Although the invention is illustrated and described herein with reference to a specific embodiment, the invention is not intended to be limited to the details shown. Rather, various modifications may be made in the details within the scope and range of equivalents of the claims and without departing from the invention.

What is claimed:

1. A phase sequence system for performing a task comprising:
a plurality of phases, wherein each phase is represented by a number;
means for arranging at least a subset of the numbers in a sequence of phases to perform the task; and
means for allowing an operator to individually edit a step in the sequence.

2. The phase sequence system according to claim 1, wherein the sequence comprises multiple listings of a particular number.

3. The phase sequence system according to claim 1, wherein the means for allowing the operator to individually edit the sequence comprises means for deleting the phase.

4. The phase sequence system according to claim 1, wherein the means for allowing the operator to individually edit the sequence comprises means for inserting additional phases.

5. The phase sequence system according to claim 1, wherein the means for allowing the operator to individually edit the sequence comprises means for exchanging a number for a different number.

6. The phase sequence system according to claim 1, wherein the means for allowing the operator to individually edit the sequence comprises means for allowing the operator to change numbers in the sequence.

7. The phase sequence system according to claim 1, wherein the means for allowing a operator to individually edit the sequence comprises means for allowing the operator to edit a time duration of the phase corresponding to the number in the sequence.

8. A method of editing steps in a process comprising the steps of:
selecting a program edit routine from an operator interface;
selecting a program to edit from the selected program edit routine;
selecting a step to edit from the selected program, wherein the step is represented by a phase number and time; and
editing the phase number.

9. The method according to claim 8, further comprising the step of editing the time.

10. The method according to claim 8, wherein editing the sequence comprises modifying the phase number.

11. The method according to claim 10, wherein modifying the phase number comprises deleting the phase number.

12. The method according to claim 10, wherein modifying the phase number comprises substituting the phase number with a different phase number.

13. The method according to claim 12, wherein modifying the phase number comprises substituting the phase number with a plurality of phase numbers.

14. The method according to claim 9, wherein editing the sequence comprises editing a time duration of operation of the phase.

15. A phase sequence system for performing a task comprising:
a controller operationally connected to a system;
operational software residing in the controller for operating the system, wherein the operational software comprises a sequence of numbers to perform the task, wherein the sequence is formed by a plurality of steps; and
a phase editor operationally connected to the controller to edit the sequence of numbers.

16. The phase sequence system according to claim 15, wherein the phase editor comprises a graphical interface.

17. The phase sequence system according to claim 15, wherein the system comprises a mechanical system.

18. The phase sequence system according to claim 15, wherein the phase editor provides means for editing operational parameters of the steps in the sequence.

19. A method of programming a series of phases to perform a task comprising the steps of:
a) providing a plurality of phases, wherein each phase is represented by a different phase number;
b) determining a phase required to perform the task;
c) selecting the phase number associated with the phase;
d) inputting the phase number into a particular step in a program; and
e) repeating steps a-d as necessary to include all of the phases necessary to complete the task.

20. The method according to claim 19, further comprising the step of providing a recipe editor to allow the editing of the numbers in the program.

21. The method according to claim 19, further comprising the step of inputting a time duration representing a time desired to operate a phase.

22. A method of performing a task comprising the steps of:
providing a system upon which the task is to be performed;
operationally connecting a controller to the system, wherein the controller includes a sequence of numbers, with each number associated with a phase; and
operating the controller, wherein the controller controls the operation of each phase according to the sequence of numbers.

23. The method according to claim 22, further comprising the step of providing an editor operationally connected to the controller to edit the sequence of numbers.
